(19) United States
(12) Patent Application Publication
(10) Pub. No.: US 2013/0217916 A1
(43) Pub. Date: Aug. 22, 2013

(54) Synthesis of Tripodal Bisphosphonate Derivatives Having an Adamantyl Basic Framework for Functionalizing Surfaces

(71) Applicants: Wolfgang Maison, Wetzlar (DE); Elisa Franzmann, Wettenberg-Wissmar (DE); Faiza Khalil, Mucke (DE)

(72) Inventors: Wolfgang Maison, Wetzlar (DE); Elisa Franzmann, Wettenberg-Wissmar (DE); Faiza Khalil, Mucke (DE)

(73) Assignee: JÜSTUS-LIEBIG-UNIVERSITÄT GIESSEN, Giessen (DE)

(21) Appl. No.: 13/821,298

(22) PCT Filed: Sep. 7, 2011
(86) PCT No.: PCT/EP2011/065489

§ 371 Date: Apr. 22, 2013

(30) Foreign Application Priority Data
Sep. 10, 2010 (EP) 10176293.8

(51) Int. Cl. C07F 9/44

(52) U.S. Cl. CPC C07F 9/4476
USPC 564/15

(57) ABSTRACT

The present invention describes tripodal catechol derivatives with an adamantyl basic framework for the functionalisation of surfaces, and methods for their production and use. A fourth remaining position of the adamantane skeleton is suitable to be optionally functionalised by so-called click reactions, for example with biomolecules, polyethylene glycol or active agents.

The compounds according to the present invention have the general formula X-Ad{(CH₂)ₙ—Y—C[PO(OH)₂]₂R¹}₃, wherein Ad stands for the adamantyl skeleton, X for a group —(CH₂)ₚ—R³, wherein p=0 to 10 and R³ is selected from —H, —NH₂, —NO₂, —OH, —SH, —O—NH₂, —NH—NH₂, —N═C═S—, —N═C═O—, —CH═CH₂, —C≡CH, —COOH, —(C═O)H, —(C═O)R⁴ Y stands for —CH₂—, —CH═CH—, —C≡C—, —O—, —S—, —S—S—, —NH—, —O—NH—, —NH—O—, —HC═N—O—, —O—N═CH—, —NR²—, -aryl-, -heteroaryl-, —(C═O)—, —O—(C═O)—, —(C═O)—O—, —NH—(C═O)—, —(C═O)—NH—, —NR²—(C═O)—, —(C═O)—NR²—, —NH—(C═O)—NH—, —NH—(C═S)—NH—, R¹ represents a hydrogen atom or a hydroxy group, R² stands for a linear or branched alkyl group and R⁴ for a linear or branched alkyl group or an aryl group. The production of the compounds occurs by reacting a compound X-Ad[(CH₂)ₙ—Y′]₃ with a reagent Y″C[PO(OH)₂]₂R¹ to the corresponding compound X-Ad{(CH₂)ₙ—Y—C[PO(OH)₂]₂R¹}₃ and subsequent purification of the reaction product. Y′ and Y″ are hereby precursors of Y. The compounds according to formula (I) according to the present invention are suitable to be used in a method to functionalise surfaces. The X group of the compounds according to the present invention is suitable to be optionally coupled to an effector, for example, by means of click chemistry.

The present invention describes tripodal catechol derivatives with an adamantyl basic framework for the functionalisation of surfaces, and methods for their production and use. A fourth remaining position of the adamantane skeleton is suitable to be optionally functionalised by so-called click reactions, for example with biomolecules, polyethylene glycol or active agents.

### DESCRIPTION OF AND INTRODUCTION TO THE GENERAL FIELD OF THE INVENTION

The present invention relates to the fields of organic chemistry and material sciences.

### STATE OF THE ART

The state of the art recognises numerous methods for the functionalisation of surfaces. Such functionalisations are used in order to modify the material properties of the surfaces in a targeted manner. Such functionalisations should be as durable as possible and allow for a highly defined loading of the surface.

In the field of medical technology, special importance is placed on functionalised surfaces. Implants should—by way of example in the dental industry and orthopedics (joint replacement)—be as biocompatible as possible, i.e. by not have, inter alia, having a tendency towards biofouling, not causing any inflammatory reactions and not being seeded with pathogenic microorganisms. Furthermore, they must permanently resist to heavy mechanical strain.

Adamantane is a rigid molecule which comprises three condensed six-member carbocyclic rings. The carbon atoms 1, 3, 5 and 7 of the adamantane are bridgehead atoms. Adamantane derivatives are known and used in medicine and material sciences. When these adamantane derivatives carry identical substituents at three bridgehead positions, they comprise a tripodal arrangement.

Bisphosphonates belong to a group of pharmaceuticals which has been developed during the last 30 years for diagnostic and therapeutic purposes relating to bone and calcium metabolic diseases. Some compounds of this type are used in pharmaceuticals for the treatment of osteoporosis. They are approved in Germany for the therapy of osteoporosis in postmenopausal women, osteodystrophia deformans and hypercalcemia associated with tumors. Furthermore, they are used in the treatment of bone metastases and fibrous dysplasia.

US 2006/0063834 A1 describes different adamantane derivatives with tripodal arrangement, methods for their production and their use for pharmaceutical compositions. However, no adamantane derivatives are disclosed which are suitable to functionalise surfaces.

In A Oganesyan, I A Cruz, R B Amador, N A Sorto, J Lozano, C E Godinez, J Anguiano, H Pace, G Sabih, C G Gutierrez: “High Yield Selective Acylation of Polyamines: Proton as Protecting Group”, Org Lett 2007, 9, 4967-4970 describes the selective acylation of polyamines which comprise several identical or similar amine functions. The authors of the paper state that the omnipresence of polyamide bindings in biological molecules converts the selective acylation into an interesting approach for the production of biomimetic molecules. However, no compounds are disclosed comprising substituted 3,4-dihydroxybenzyl groups as ligands of the adamantane which serve to functionalise surfaces.

Methods for the production of rigid tripodal compounds based on adamantane are described in W Maison, J V Frangioni, N Pannier: “Synthesis of Rigid Multivalent Scaffolds Based on Adamantane”, Org Lett 2004, 6, 4567-4569 and in N Pannier, W Maison: “Rigid C₃-Symmetric Scaffolds Based on Adamantane”, Eur J Org Chem 2008, 1278-1284 and in K Nasr, N Pannier, J V Frangioni, W Maison: “Rigid Multivalent Scaffolds Based on Adamantane”, J Org Chem 2008, 73, 1058-1060. The production of trivalent adamantane skeletons with ligands comprising bisphosphonate units is not disclosed here.

Ongoing research with the aim to find bone specific therapeutics based on bisphosphonates is described in S Zhang, G Gangal, H Uludag: “'Magic bullets' for bone diseases: progress in rational design of bone-seeking medicinal agents”, Chem Soc Rev 2007, 36, 507-531. In R S Ehrick, M Capaccio, D A Puleo, L G Bachas: “Ligand-Modified Aminobisphosphonate for Linking Proteins to Hydroxyapatite and Bone Surface”, Bioconjugate Chem 2008, 19, 315-321, a synthesis route for binding tetraethyl(aminomethylene)bisphosphonate (AMB) to biotin and AMB biotin to hydroxylapatite.

Until now, the state of the art does not know a way of combining bisphosphonates and adamantane in such a way that bisphosphonate units are suitable to be bonded to trivalent adamantane skeletons.

For the first time, the present invention provides such trivalent adamantane skeletons with ligands comprising bisphosphonate units. The compounds according to the present invention comprise tripodal basic skeletons on the basis of the adamantane to which three bisphosphonate units are bound in the bridgehead positions. The remaining fourth bridgehead position is easily suitable to be further functionalised via so-called click reactions, e.g. with biomolecules, dyes, radiomarkers, polyethylene glycol or active agents.

### Task

The aim of the present invention is to provide compounds which allow for a durable functionalisation and a highly defined loading of surfaces, and methods for the production of these compounds.

### Achievement of this Aim

The task, namely to provide compounds which allow for a durable functionalisation and a highly defined loading of surfaces is achieved according to the present invention via compounds according to formula (I):

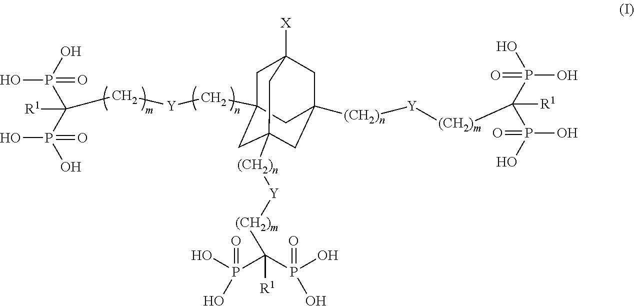

wherein
n and m stand independently of one another for integers between 0 and 10,
R¹ is a hydrogen atom or a hydroxy group,
Y is selected from —CH₂—, —CH═CH—, —C═C—, —O—, —S—, —S—S—, —NH—, —O—NH—, —NH—O—, —HC═N—O—, —O—N═CH—, —NR²—, -aryl-, -heteroaryl-, —(C═O)—, —O—(C═O)—, —(C═O)—O—, —NH—(C═O)—, —(C═O)—NH—, —NR²—(C═O)—, —(C═O)—NR²—, —NH—(C═O)—NH—, —NH—(C═S)—NH—, wherein R² stands for a linear alkyl group with 1 to 10 C atoms or a branched or cyclic alkyl group with 3 to 10 C atoms,
   and
X stands for a group —(CH₂)ₚ—R³, wherein p═0 to 10 and R³ is selected from —H, —NH₂, —NO₂, —OH, —SH, —O—NH₂, —NH—NH₂, —N═C═S—, —N═C═O—, —CH=CH₂, —C≡CH, —COOH, —(C═O)H, —(C═O)R⁴, wherein the hydroxy, thio, amino or CO═O groups are optionally suitable to be protected by a protective group, —N₃, —OR⁴, —COOR⁴, —NHR⁴, —NR⁴R⁵, —CO—NHR⁴, —CONR⁴R⁵, —NH—CO—R⁴, 4-(2,5-dioxopyrrol-1-yl), wherein R⁴ and R⁵ stand independently of one another for a linear alkyl group with 1 to 10 C atoms, a linear alkenyl or alkynyl group with 2 to 10 C atoms, a branched alkyl, alkenyl or alkynyl group with 3 to 10 C atoms or a cyclic alkyl or alkenyl group with 3 to 10 C atoms, or
X stands for a branched alkyl, alkenyl or alkynyl group with 3 to 10 C atoms or a cyclic alkyl, alkenyl or alkynyl group with 3 to 10 C atoms or for an aryl or heteroaryl group, wherein, in the event that X is a branched alkyl, alkenyl and alkynyl group, a cyclic alkyl or alkenyl group, an aryl or heteroaryl group, one C atom of this group X is optionally suitable to carry one group R³ according to the definition above.

The compounds according to the present invention, the method for their production and the use of these compounds are explained hereinafter.

The invention is not limited to one of the embodiments described hereinafter; rather, it is suitable to be modified in various different ways.

All of the characteristics and advantages originating from the claims, description and figures (including constructive details, spatial arrangements and processing steps) are suitable to be essential to the invention, both in themselves and in the most various combinations.

The compounds according to formula (I) according to the present invention allow for a durable functionalisation and a highly defined loading of surfaces. Surfaces which are suitable to be functionalised and loaded comprise metals, metal oxides, apatite, glass and mixtures thereof. The term “apatite” hereby comprises both compounds following the general formula Ca₅(PO₄)₃(F,Cl,OH), in which the concentration of fluoride, chloride and hydroxyl ions is freely exchangeable, and the single minerals fluoroapatite, chloroapatite and hydroxylapatite.

Under “highly defined loading” is understood that the loading of the surface allows for a gap-free coating of the material in the form of a monolayer. “Monolayer” is understood to mean a layer of molecules according to the present invention on the surface which has a height of just a single molecule. A “functionalisation” is the addition of functional groups to the surface of a material via chemical synthesis methods. A coating of surfaces with the compounds according to the present invention thus represents a functionalisation of these surfaces. An effector molecule is optionally suitable to be bonded to the group X. This represents another functionalisation. An effector is a molecule or a molecule component which causes a physical, chemical, biochemical or biological process or controls, activates or inactivates such an effect. Examples for effectors are dyes, radioactive molecules, biomolecules such as amino acids, sugar, peptides, proteins, DNA, RNA, polymers such as ethylene glycol and derivatives thereof as well as active agents. Substances are referred to as active agents if they cause a specific effect or a reaction in low doses within an organism.

Due to the multivalent binding of the compounds according to formula (I), this functionalisation is durable in comparison to molecular exchange processes on the surface (such as the hydrolysis of the coupling in aqueous media) and also in comparison to mechanical strain.

It is known to persons skilled in the art that cyclic alkyl and alkenyl groups have to comprise at least three carbon atoms. In the context of the present invention, “annular” groups are understood to mean such groups in which all carbon atoms are involved in the ring formation. Furthermore, “cyclic” groups are suitable to also comprise acyclic carbon atoms. In the context of the present invention, annular alkyl and alkenyl groups are propyl, butyl, pentyl, hexyl, heptyl, octyl, nonyl, decyl, propenyl, butenyl, pentenyl, hexenyl, heptenyl, octenyl, nonenyl and decenyl rings. If the groups X, R⁴ and/or R⁵ are cyclic alkyl or alkenyl groups, they are selected from the aforementioned annular alkyl and alkenyl groups which do not carry further substituents, and from the aforementioned annular alkyl and alkenyl groups which are themselves bonded to one or several acyclic alkyl, alkenyl or alkynyl groups. In the latter case, the binding of the cyclic alkyl or alkenyl group to the Cl atom of the adamantane skeleton (provided that the cyclic group represents X) or to the respective atom of the group R⁵ (provided that the cyclic group represents R⁴ or R⁵) is suitable to occur via a cyclic or acyclic carbon atom of the cyclic alkyl or alkylene group. According to the above definition of the term “alkyl group”, cyclic alkyl groups also comprise a total of 10 carbon atoms maximum.

According to the present invention, the group X is a group —(CH₂)ₚ—R³. If R³ is —NH₂, —OH, —SH, —O—NH₂, —NH—NH—COOH, —(C═O)H, —(C═O)R⁴, these groups are optionally suitable to be protected by a protective group. Protective groups for hydroxy, thiol, amino, carbonyl and carboxyl groups are known by persons skilled in the art. They are able to use these protective groups, i.e. to introduce and, if required, cleave them off again, without leaving the scope of protection of the patent claims.

By way of non-exhaustive example the following protective groups are to be named:
for the OH group: methoxy methyl ether (MOM), β-methoxy ethoxy methyl ether (MEM), silyl ether, 2-tetrahydropyranyl (THP), acetyl (Ac), benzoyl (Bz), benzyl (Bn, Bnl), dimethoxytrityl (DMT), methoxytrityl (MMT), p-methoxy benzyl ether (PMB), methylthiomethyl ether, pivaloyl (piv), methylether, ethoxyethyl ether (EE)
for the SH group: tert-butyl, 2-tetrahydropyranyl, acetyl, 2-nitropyranyl, phenacyl, (cumarin-4-yl)methyl
for the NH₂ group: 1-(1-adamantyl)-1-methoxycarbonyl (ADPOC), allyl-oxycarbonyl (ALLOC), benzyloxycarbonyl (abbreviated by Z or Cbz), 9-fluorenylmethoxycarbonyl (FMOC), p-methoxybenzyl carbonyl (Moz, MeOZ), tert-butyloxycarbonyl (BOC), acetyl (ac), benzoyl (Bz), benzyl (Bn, Bnl), p-methoxybenzyl (PMB), 3,4-dimethoxybenzyl (DMPM), p-methoxyphenyl (PMP), Tosyl (ts), sulfonamides
for the carbonyl group (in aldehydes and ketones): the reaction with diols to acetals or ketals
for the COOH group: methylester, benzyl ester, tert-butyl ester, silyl ester, orthoester, oxazolines

According to the present invention, aryl groups are understood to mean phenyl, naphthyl and anthracenyl groups.

Heteroaryl groups are selected from furanyl, pyrrolyl, thiophenyl, imidazolyl, pyrazolyl, triazolyl, thiazolyl, oxazolyl, isooxazolyl, one oxadiazolyl, pyridinyl, pyrazinyl, pyrimidinyl, pyridazinyl, one triazinyl, one tetrazinyl, 1,4-dioxinyl, one thiazinyl, one oxazinyl, one azepinyl, a diazepinyl, benzofuranyl, isobenzofuranyl, indolyl, isoindolyl, benzothiophenyl, benzo[c]thiophenyl, benzimidazolyl, purinyl, indazolyl, benzoxazolyl, benzisoxazolyl, benzothiazolyl, quinolinyl, isochinolinyl, chinoxalinyl, acridinyl, chinazolinyl and cinnolinyl.

In an advantageous embodiment, Y is selected from no atom, —CH₂—, —NH—(C═O)—, —(C═O)—NH—, —NR²—, wherein R² is as defined above.

In another advantageous embodiment, n is an integer between 0 and 3.

In another advantageous embodiment, m is an integer between 0 and 3.

Particularly advantageously, n and m stand independently of one another for integers between 0 and 3.

In a further advantageous embodiment, X represents a group (—CH₂)ₚ—R³, wherein p represents an integer between 0 and 3 and R³ is defined as in claim 1.

In a further advantageous embodiment, X stands for —(CH₂)ₚ—R³, wherein R³ is selected from —H, —OH, —NH₂, —NO₂, —NH—NH₂, —NHR⁴, —NR⁴R⁵, —O—NH₂, —NH—(C═O)—C≡CH, —C≡CH, —N═C═S, —N═C═O, —COOH, —(C═O)H, —(C═O)R⁴ and wherein p represents an integer between 0 and 3, and R⁴ and R⁵ are defined as above.

The compounds according to the present invention according to formula (I) are produced by reacting a compound X-Ad[(CH₂)ₙ—Y′]₃ with a reagent Y″C[PO(OH)₂]₂R¹ to the corresponding compound X-Ad{(CH₂)ₙ—Y—C[PO(OH)₂]₂R¹}₃ and by subsequent purification of the reaction product, wherein Ad stands for the adamantyl skeleton and Y′ for a precursor of the group Y according to formula (I) and wherein X, R¹ and n are defined as in formula (I).

Precursor is hereby understood to refer to a functional group which is converted via reaction with another functional group acting as precursor or a further reagent acting as precursor into a functional group according to formula (I).

Compounds of the formula X-Ad[(CH₂)ₙ—Y′]₃ are known. Persons skilled in the art are able to commercially purchase them or produce them independently with the help of their specialist knowledge following known synthesis procedures.

In an advantageous embodiment, X is a hydrogen atom.

In another advantageous embodiment, X is a group —(CH₂)ₚ—R⁵, wherein p represents an integer between 0 and 3, and R⁵ is selected from —OH, —NH₂, —NH—NH₂, —NHR⁶, —NR⁶R⁷, —O—NH₂, —NH—(C═O)—C≡CH, —C≡CH, —N═C═S, —N═C═O, —COOH, —(C═O)H, —(C═O)R⁶, wherein R⁶ and R⁷ are defined as in formula (I). As already indicated, these groups may be optionally protected via a protective group (Pg). If these groups are protected, this occurs before the reaction with the reagent Y″Z, so that in this case Pg-X-Ad[(CH₂)ₙ—Y′]₃ is reacted with the reagent Y″C[PO(OH)₂]₂R¹ to the corresponding compound Pg-X-Ad{(CH₂)ₙ—Y—C[PO(OH)₂]₂R¹}₃.

Suitable protective groups are described above. It is known to persons skilled in the art how to introduce these protective group and remove them again. Persons skilled in the art are able to apply this knowledge without leaving the scope of protection of the patent claims.

The purification of the reaction product occurs, by way of example by removing the solvent, adding the residue to a mixture comprising a polar aprotic solvent such as ethyl acetate and a diluted mineral acid, e.g. diluted hydrochloric acid, washing with a saturated KHSO₄ solution and drying.

In an advantageous embodiment, Y″C[PO(OH)₂]₂R¹ is an amino or alcohol functionalised bisphosphonate, such as pamidronate or alendronate and their protected derivatives. In this case, X-Ad[(CH₂)ₙ—Y′]₃ or Pg-X-Ad[(CH₂)ₙ—Y′]₃ is reacted with Y″C[PO(OH)₂]₂R¹ in the presence of an activation reagent and a coupling additive. Y′ is hereby a carboxylic acid residue or a derivative thereof. Suitable activating reagents are, by way of example, EDC, DCC, DCI, PyClop, HBTU, HATU, HOSu, TBTU, T3P, BopCl and 3-Cl-1-pyridinium iodide. The substances HOBT, HOAt, HONB and NHS known to persons skilled in the art are usable, by way of example, as coupling additives. It is known to persons skilled in the art that these reactions are appropriately carried out with the addition of a base such as DIPEA. Persons skilled in the art are furthermore aware of different solvents to be used in the methods mentioned. They are able to independently produce these combinations of activating reagents, coupling additives, bases and solvents using their conventional knowledge and standard literature.

If a protective group Pg has been introduced and/or protected bisphosphonates have been used, these protective groups are removed at the end, and the deprotected product is subsequently purified.

In another advantageous embodiment, Y″C[PO(OH)₂]₂R¹ is an carboxyl functionalised bisphosphonate, such as dicarboxypropane-1,1-diphosphonate (DPD) or one of its protected derivatives. In this case, X-Ad[(CH₂)ₙ—Y′]₃ or Pg-X-Ad[(CH₂)ₙ—Y′]₃ is reacted with Y″C[PO(OH)₂]₂R¹ in the presence of an activating reagent and a coupling additive. Y′ is hereby advantageously an alcohol or amine function. Suitable activating reagents are, by way of example, EDC, DCC, DCl, PyClop, HBTU, HATU, HOSu, TBTU, T3P, BopCl and 3-Cl-1-pyridinium iodide. The substances HOBT, HOAt and HONB known to persons skilled in the art are usable, by way of example, as coupling additives. It is known to persons skilled in the art that these reactions are appropriately carried out with the addition of a base such as DIPEA. Persons skilled in the art are furthermore aware of different solvents to be used in the methods mentioned. They are able to independently produce these combinations of activating reagents, coupling additives, bases and solvents using their conventional knowledge and standard literature.

In an advantageous embodiment, Y″C[PO(OH)₂]₂R¹ is an amino-functionalised bisphosphonate such as pamidronate or alendronate and their protected derivatives. X-Ad[(CH₂)ₙ—Y′]₃ or Pg-X-Ad[(CH₂)ₙ—Y′]₃ is reacted with the Y″C[PO(OH)₂]₂R¹ in the presence of a means of reduction. Y′ is hereby an aldehyde or a ketone. Suitable means of reduction are, by way of example, NaBH₄, NaBH₃CN, NaBH(OAc)₃, as well as H₂ and metal catalysts. Persons skilled in the art know different solvents to be used in the methods mentioned. They are able to independently produce these combinations of means of reduction and solvents using their conventional knowledge and standard literature.

In another advantageous embodiment, Y″C[PO(OH)₂]₂R¹ is an amino or alcohol functionalised bisphosphonate, such as pamidronate or alendronate and their protected derivatives. X-Ad[(CH₂)ₙ—Y′]₃ or Prot-X-Ad[(CH₂)ₙ—Y′]₃ with a suitable leaving group Y′ is reacted with Y″C[PO(OH)₂]₂R¹. Suitable leaving groups are, by way of example, -OTs, OMs, -OTf and halides. Persons skilled in the art know different solvents to be used in the methods mentioned. They are able to independently produce these combinations of leaving groups and solvents using their conventional knowledge and standard literature.

In an advantageous embodiment, Y″C[PO(OH)₂]₂R¹ is an amino functionalised bisphosphonate, such as pamidronate or alendronate and their protected derivatives. X-Ad[(CH₂)ₙ—Y′]₃ or Pg-X-Ad[(CH₂)ₙ—Y′]₃ is reacted with Y″C[PO(OH)₂]₂R¹. Y′ is hereby an isothiocyanate or an isocyanate. Persons skilled in the art know different solvents to be used in the methods mentioned. They are able to independently produce these combinations of means of reduction and solvents using their conventional knowledge and standard literature.

In another advantageous embodiment, Y″C[PO(OH)₂]₂R¹ is a carbonyl functionalised bisphosphonate or a protected derivative thereof. X-Ad[(CH2)n-Y′]₃ or Pg-X-Ad[(CH2)n-Y′]₃ is reacted with Y″C[PO(OH)₂]₂R¹. Y′ is hereby an O-alkylhydroxylamine or the corresponding hydrohalide. Persons skilled in the art know different solvents to be used in the methods mentioned.

In another advantageous embodiment, Y″C[PO(OH)₂]₂R¹ is an azide functionalised bisphosphonate or a protected derivative thereof. X-Ad[(CH₂)ₙ—Y′]₃ or Pg-X-Ad[(CH₂)ₙ—Y′]₃ is reacted with the Y″C[PO(OH)₂]₂R¹ in the presence of a copper catalyst. Y′ is hereby an alkyne. Persons skilled in the art know different solvents and copper catalysts to be used in the methods mentioned. They are able to independently produce these combinations of catalysts and solvents using their conventional knowledge and standard literature.

In another advantageous embodiment, Y″C[PO(OH)₂]₂R¹ is an alkyne functionalised bisphosphonate or a protected derivative thereof. X-Ad[(CH₂)ₙ—Y′]₃ or Pg-X-Ad[(CH₂)ₙ—Y′]₃ is reacted with the Y″C[PO(OH)₂]₂R¹ in the presence of a copper catalyst. Y′ is hereby an azide. Persons skilled in the art know different solvents and copper catalysts to be used in the methods mentioned. They are able to independently produce these combinations of catalysts and solvents using their conventional knowledge and standard literature.

If a protective group Pg has been introduced, these protective groups are optionally removed at the end, i.e. after the formation of Pg-X-Ad{(CH₂)ₙ—Y—C[PO(OH)₂]₂R¹}₃, and the deprotected product is subsequently purified.

The compounds according to formula (I) according to the present invention are suitable to be used in a method to functionalise surfaces. The functionalisation hereby occurs via dip and rinse by dipping the surfaces to be functionalised into a solution of the compounds according to the present invention.

The compounds according to the present invention are advantageously dissolved in an aqueous buffer solution which comprises a salt concentration significantly higher than physiological salt concentrations (0.9 wt.-% of NaCl). MOPS (3(N-morpholine)-propane sulfonic acid) is, by way of example, a suitable buffer. NaCl and K₂SO₄ and mixtures thereof are suitable salts. The salt concentration advantageously amounts to between 10 and 20 wt.-% and the buffer concentration to between 0.05 and 0.2 mmol.

The X group of the compounds according to the present invention is suitable to be optionally coupled to an effector. The coupling of X to the effector is hereby suitable to be carried out both in solution, i.e. before the functionalisation of the surface, as well as on the surface, i.e. after the functionalisation of the surface.

Effectors are, by way of example, ether groups, ester groups, heteroaromatic compounds, dyes, metal complexes, polymers (for example polyethylene glycols), pharmaceutical active agents (for example antibiotics, bisphosphonates), biomolecules (for example an amino acid), peptides, carbohydrates and terpenes. If the effector is a polymer and if this is a polyethylene glycol, it is advantageously a group —(O—CH₂—CH₂)_{q}—R³ or —(CH₂—CH₂—O)_{q}—R³, wherein q is a number between 1 and 10, and R³ is defined as described under formula 1.

In an advantageous embodiment, the coupling of X is carried out by means of click chemistry. “Click reactions” are understood by persons skilled in the art to be energetically favoured reactions which run specifically and result in a single product. These are efficient reactions which are suitable to be carried out very easily. Click reactions are used in molecular biology, the development of active agents, biotechnology, macromolecular chemistry and material sciences.

The concept of the click reaction was established by K. Barry Sharpless and describes reactions which
are structured in a modular manner,
comprise a wide scope of application,
are suitable to be carried out with high yields,
occur stereospecifically,
allow for simple reaction conditions (as non-sensitive as possible against water and oxygen),
occur in environmentally-friendly solvents and/or solvents which are easily removable, such as water, or occur in a solvent-free manner,
require simple purification (extraction, phase separation, distillation or crystalisation) or no purification at all.

“Click reactions” are, in general, strongly thermodynamically favoured. This is frequently more than 84 kJ/mol, which results in a fast reaction with high selectivity for a single product. These are frequently carbon-heteroatom bond formations.

Chemical reactions which fulfill these criteria are:
the carbonyl chemistry of the “non-aldol type”, such as the formation of urea, thiourea, oximes, imines, aromatic heterocycles and hydrazones, and the formation of carbamides and amides,
cyclo additions to unsaturated C—C bonds, in particular 1,3-dipolar cyclo additions such as the Huisgen cycloaddition, and also Diels-Alder reactions,
nucleophilic substitutions, in particular the ring opening of strained, electrophilic heterocycles such as aziridines and epoxides,
addition reactions at C—C multiple bonds, mostly in an oxidative manner such as, by way of example epoxidation, aziridination or dihydroxylation, but also Michael additions of Nu-H, wherein Nu is a nucleophile.

In another advantageous embodiment, the coupling of the effector to the X group occurs via conventional substitution or addition reactions which do not belong to the abovementioned conditions of a click reaction. These conventional reactions comprise, by way of example, the formation of ether, the esterification of a carboxylic acid or the formation of amide.

Particularly advantageously, the surfaces to be functionalised are metallic surfaces comprising iron and/or titanium or surfaces comprising apatite and/or glass. It is known to persons skilled in the art that bones of vertebrates comprise approximately 50% apatite, approximately 70% dentine and more than 95% tooth enamel. Modern dental prostheses, such as dental fillings and implants, frequently comprise apatite and/or devices which comprise iron and/or titanium. It is furthermore known that the surfaces of endosprostheses, for example for hip and knee joints, comprise iron and/or titanium. The compounds according to the present invention according to formula (I) as well as the compounds which are suitable to be obtained from them and coupled to an effector, are therefore suitable for the surface functionalisation of dental and joint endosprotheses.

### PRACTICAL EMBODIMENTS

### Practical Embodiment 1

Production of 3,5,7-tris[2-(N-hydroxysuccinimido)-carboxyethyl]-adamantane 1

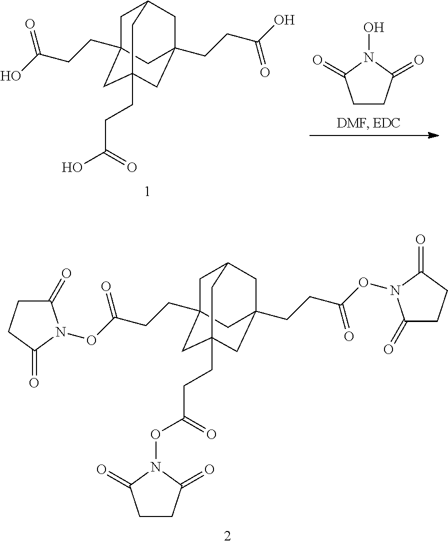 [SMILES: O=C(O)CCC12CC3CC(CCC(=O)O)(C1)CC(CCC(=O)O)(C3)C2 ; O=C1CCC(=O)N1O ; O=C(CCC12CC3CC(CCC(=O)ON4C(=O)CCC4=O)(C1)CC(CCC(=O)ON1C(=O)CCC1=O)(C3)C2)ON1C(=O)CCC1=O]

979 mg (5.11 mmol) EDC-hydrochloride (1-ethyl-3(3-dimethylaminopropyl)carbodiimide) was added at room temperature to a solution of 500 mg (1.42 mmol) of the tricarboxylic acid 1 and 588 mg (5.11 mmol) N-hydroxysucccinimide in 50 ml absolutised DMF. The reaction solution was stirred for 24 h at room temperature. Subsequently, the solvent was distilled off. The residue obtained was taken up in ethyl acetate, washed three times with water and dried over Na₂SO₄, and the solvent was distilled off. 447 mg of a colourless solid 2 was able to be obtained which was used without further purification. ¹H-NMR (400 MHz, CDCl₃): δ [ppm]=2.80 (m, 12 H, 9-H), 2.57 (t, 6H, ³J=9.0 Hz, 6-H), 1.60 (t, 6H, ³J=8.0 Hz, 5-H), 1.37 (m, 6H, 2-H), 1.20 (d, 3 H, ²J=12.0 Hz, 4a-H), 1.14 (d, 3H, ²J=12.0 Hz, 4b-H); ¹³C-NMR (100 MHz, CDCl₃): δ [ppm]=169.5 (C7), 169.4 (C8), 40.6 (C2), 37.4 (C5), 33.5 (C3), 31.6 (C6), 29.1 (C1), 25.6 (C9) MS-ESI m/z (%): 666.3 [MNa]⁺(100), 1309.9 [2×MNa]⁺(11)

### Practical Embodiment 2

Production of compound 3

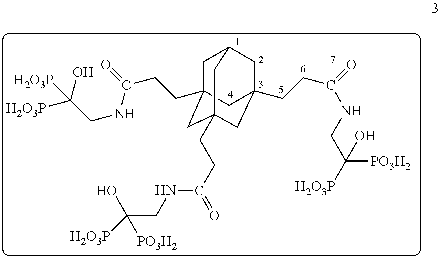

100 mg (0.155 mmol) of the NHS ester compound 2 was dissolved in 10 mL DCM, 10 mL DMF and 40 H₂O, and 4.3 mL (31.07 mmol) dest. Et₃N and 369 mg (1.55 mmol) pamidronate were added and stirred for 5 days at room temperature. The solvent was reduced to dryness, and the crude product was purified by means of column chromatography via an RP-HPLC (RP8). (previous MS measurements resulted in a complete reaction) A gradient of 1% acetonitrile, 99% water was used isocratically over 15 min.

MS-ESI mlz (%): 960.1 [M-H]⁻(100)

1. A compound according to formula (I) 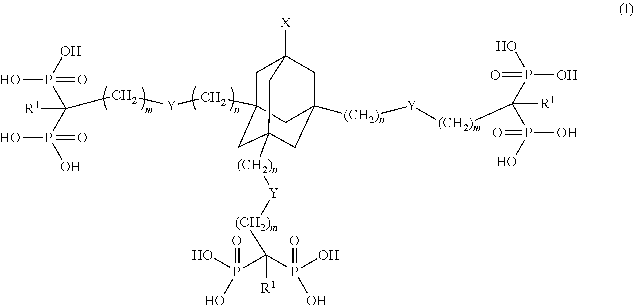
wherein
n and m each, independently, is an integer between 0 and 10,
R¹ is a hydrogen atom or a hydroxy group,
Y is a bond, —CH₂—, —CH═CH—, —C═C—, —O—, —S—, —S—S—, —NH—, —O—NH—, —NH—O—, —HC═N—O—, —O—N═CH—, —NR²—, -aryl-, -heteroaryl-, —(C═O)—, —O—(C═O)—, —(C═O)—O—, —NH—(C═O)—, —(C═O)—NH—, —NR²—(C═O)—, —(C═O)—NR²—, —NH—(C═O)—NH—, or —NH—(C═S)—NH—,
R² is a linear alkyl group with 1 to 10 C atoms or a branched or cyclic alkyl group with 3 to 10 C atoms,
X is —(CH₂)ₚ—R³; a branched alkyl, alkenyl or alkynyl group with 3 to 10 C atoms; a cyclic alkyl, alkenyl or alkynyl group with 3 to 10 C atoms; or an aryl or heteroaryl group,
p is an integer between 0 and 10
R³ is —H, —NH₂, —NO₂, —OH, —SH, —O—NH₂, —NH—NH₂, —N═C═S—, —N═C═O—, —CH═CH₂, —C≡CH, —COOH, —(C═O)H, or —(C═O)R⁴ wherein the hydroxy, thio, amino or C═O groups are optionally suitable to be protected by a protective group, —N₃, —OR⁴, —COOR⁴, —NR⁴R⁵, —CO—NHR⁴, —CONR⁴R⁵, —NH—CO—R⁴, or 4-(2,5-dioxopyrrol-1-yl), and
R⁴ and R⁵ each, independently, is a linear alkyl group with 1 to 10 C atoms, a linear alkenyl or alkynyl group with 2 to 10 C atoms, a branched alkyl, alkenyl or alkynyl group with 3 to 10 C atoms, or a cyclic alkyl or alkenyl group with 3 to 10 C atoms,
wherein, if X is a branched alkyl, alkenyl and alkynyl group, a cyclic alkyl or alkenyl group, an aryl or heteroaryl group, then one C atom of this group X is optionally substituted with R³.

2. The compound according to claim 1, wherein Y is a bond, —CH₂—, —NH—(C═O)—, —(C═O)—NH—, or —NR¹.

3. The compound according to claim 1, wherein n is an integer between 0 and 3.

4. The compound according to claim 1, wherein m is an integer between 0 and 3.

5. The compound according to claim 1, wherein X is —(CH₂)ₚ—R³, and p is an integer between 0 and 3.

6. The compound according to claim 1, wherein
X is —(CH₂)ₚ—R³,
R³ is —H, —OH, —NH₂, —NO₂, —NH—NH₂, —NR⁴R⁵, —O—NH₂, —NH—(C═O)—C≡CH, —C≡CH, —N═C═S, —N═C═O, —COOH, —(C═O)H, or —(C═O)R⁴, and
p is an integer between 0 and 3.

7. A method for the production of a compound according to claim 1, the method comprising:
reacting a compound X-Ad[(CH₂)ₙ—Y′]₃ with a reagent Y″C[PO(OH)₂]₂R¹ to produce X-Ad{(CH₂)ₙ—Y—C[PO(OH)₂]₂R¹}₃ as a reaction product, and
purifying the reaction product,
wherein Ad is the adamantly skeleton, and Y′ and Y″ are precursors of Y.

8. The method according to claim 7, wherein X is a hydrogen atom.

9. The method according to claim 7, wherein
X is —(CH₂)ₚ—R³,
R³ is selected from —OH, —NH₂, —NO₂, —NH—NH₂, —NR⁴R⁵, —O—N H₂, —NH—(C═O)—C≡CH, —C≡CH, —N═C═S, —N═C═O, —COOH, —(C═O)H, or —(C═O)R⁴, and
p is an integer between 0 and 3.

10. The method according to claim 9, wherein R³ is protected by a protective group (Pg) prior to reacting the compound with the reagent Y″C[PO(OH)₂]₂R¹, so that the compound Pg-X-Ad[(CH₂)ₙ—Y′]₃ is reacted with the reagent to produce a corresponding compound Pg-X-Ad{(CH₂)ₙ—Y—C[PO(OH)₂]₂R¹}₃.

11. (canceled)

12. (canceled)

13. (canceled)
